(19) United States
(12) Patent Application Publication
(10) Pub. No.: US 2006/0169550 A1
(43) Pub. Date: Aug. 3, 2006

(54) Electromagnetic brake assembly

(76) Inventor: James W. Albrecht, Centerville, OH (US)

Correspondence Address: BRACEWELL & GIULIANI LLP, P.O. BOX 61389, HOUSTON, TX, 77208-1389, US

(21) Appl. No.: 11/046,041

(22) Filed: Jan. 28, 2005

(51) Int. Cl. F16D 65/00

(52) U.S. Cl. 188/161; 188/73.1

(57) ABSTRACT

An electromagnetic brake apparatus is provided. The invention includes a coil body, an electromagnetic coil and a spring housed in the coil body. The invention also includes a brake pad, and a mounting plate spaced from the coil body and supporting the brake pad. The invention also includes an armature plate between the spring and the brake pad in electromagnetic communication with the electromagnetic coil which is drawn toward the coil body and away from the brake pad when the electromagnetic coil increases the magnetic field and which is forced by the spring away from the coil body and into contact with the brake pad when the electromagnetic coil decreases the magnetic field. The invention also includes an annular spacer ring extending circumferentially around an axis of the coil body between the coil body and the mounting plate which fixes the amount of separation between the coil body and the mounting plate.

### 1. FIELD OF THE INVENTION

The invention relates generally to an electromagnetic brake assembly, and more particularly to an electromagnetic brake assembly with a spacer ring and a manual release mechanism.

### 2. BACKGROUND OF THE INVENTION

Various types of brakes are conventionally utilized to decelerate the wheel of a vehicle in order to slow the vehicle or bring the vehicle to a stop. One type of conventional brake is an electromagnetic brake assembly, as shown in FIG. 1. This type of brake features an electromagnetic coil housed in a coil body that creates an electromagnetic field. The electromagnetic field acts on an armature plate that is either applied to or released from a brake pad mounted to a friction plate, depending on the degree of force exerted by the electromagnetic field. Generally, when the voltage is lowered or cut-off from the electromagnetic coil, a spring attached to an armature plate forces the armature plate against the brake pad, which acts to decelerate the wheel of the vehicle. On the other hand, when voltage is raised or applied to the electromagnetic coil, the electromagnetic field draws the armature plate toward the coil, which acts to release the armature plate from the brake pad and operates to cease the braking effect on the wheel of the vehicle.

Prior versions of electromagnetic brake assemblies featured one or more spacer sleeves, as shown in FIG. 2. The spacer sleeves were used to maintain a minimum distance of separation between the coil body and the friction plate. Each spacer sleeve slipped over one of the fasteners between the coil body and the mounting plate.

Prior versions of electromagnetic brake assemblies also featured safety characteristics, such as an automatic lock-up feature, causing the armature plate to forcibly impact the brake pad, thus immediately and unequivocally stopping the vehicle upon absence of voltage. Such a lock-up feature, however, creates a situation where the armature plate is in a locked position against the brake pad. For example, a failure of electrical power to a coil body may cause a brake to lock. In this scenario, release of an armature plate from a brake pad is no longer achievable through electronic or electromagnetic means. This lock-up may make it more difficult for the operator to tow the vehicle. If such a problem arises, it is necessary to create a manual operation of releasing the armature plate from the brake pad. Various manual releases have been used in the past.

### 3. SUMMARY

The present invention advantageously provides an electromagnetic brake apparatus for decelerating a rotating shaft of apiece of equipment. The invention includes a coil body, an electromagnetic coil and a spring housed in the coil body. The invention also includes a brake pad, and a mounting plate spaced from the coil body and supporting the brake pad. The invention also includes an armature plate between the spring and the brake pad in electromagnetic communication with the electromagnetic coil which is drawn toward the coil body and away from the brake pad when the electromagnetic coil increases the magnetic field and which is forced by the spring away from the coil body and into contact with the brake pad when the electromagnetic coil decreases the magnetic field. The invention also includes an annular spacer ring extending circumferentially around an axis of the coil body between the coil body and the mounting plate which fixes the amount of separation between the coil body and the mounting plate.

### 4. BRIEF DESCRIPTION OF THE DRAWINGS

FIG. 1 shows a sectional view of a prior version of an electromagnetic brake assembly, including an illustration of spacer sleeves.

FIG. 2 shows a sectional view of an electromagnetic brake assembly, including an illustration of an annular spacer ring in accordance with the invention.

FIG. 3 shows a sectional view of an electromagnetic brake assembly, including an illustration of a threaded screw stud and nut in accordance with the invention.

FIG. 4 shows a left-side isometric view of an electromagnetic brake assembly, including an illustration of an annular spacer ring and a threaded screw stud and nut, in accordance with the invention.

FIG. 5 shows a right-side isometric view of an electromagnetic brake assembly, including an illustration of an annular spacer ring and a threaded screw stud and nut, in accordance with the invention.

FIG. 6 shows a sectional view of the electromagnetic brake assembly taken along the line 6-6 in FIG. 5.

### 5. DETAILED DESCRIPTION OF THE INVENTION

Although the following detailed description contains many specific details for purposes of illustration, anyone of ordinary skill in the art will appreciate that many variations and alterations to the following details are within the scope of the invention. Accordingly, the exemplary embodiment of the invention described below is set forth without any loss of generality to, and without imposing limitations thereon, the claimed invention.

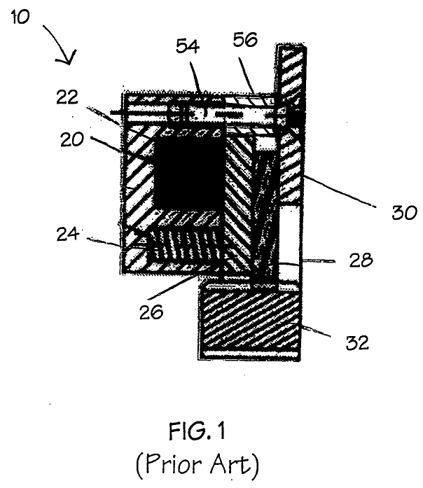

FIG. 1 shows an embodiment of a prior version of an electromagnetic brake assembly 10. A coil body 20 surrounds a hub 32 which receives a drive shaft of a vehicle or other assembly such as a conveyor. An electromagnetic coil 22 and a plurality of coil springs 24 are housed within the coil body 20, and are exposed to an armature plate 26 positioned on one side of the coil body 20. A mounting plate 30 is fixed in place around the hub 32, and supports a brake pad 28 securely mounted on the side of the mounting plate 30 facing the armature plate 26 and the coil body 20. The brake plate 28 interfaces the mounting plate 30 in a parallel relationship. The armature plate 26 is in contact with the ends of the springs 24 and in electromagnetic communication with the part of the electromagnetic coil 22 exposed from the coil body 20. The armature plate 26 is in a parallel relationship with the brake pad 28 and the mounting plate 30.

The armature plate 26 is in electromagnetic communication with the electromagnetic coil 42 and is moveable relative to coil body 20 and mounting plate 30. The armature plate 26 is in a parallel relationship with the brake pad 28 and the mounting plate 30. A plurality of bolts 54 are positioned radially outward from and perpendicular to the armature plate 46. Bolts 54 are spaced circumferentially around the axis of coil body 20 and secure the coil body 20 to mounting plate 30. In this prior version of FIG. 1, bolts 54 secure to threaded holes in coil body 20. A spacer sleeve 56 slides over each bolt 54. One end of the spacer sleeve 56 abuts coil body 20 and another end abuts mounting plate 30 to create a fixed separation between the coil body 20 and the mounting plate 30.

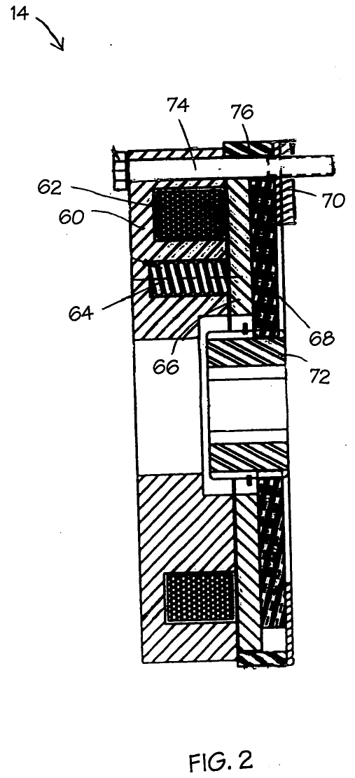

FIG. 2 shows an embodiment of an electromagnetic brake assembly 14 in accordance with the invention. The embodiment shown in FIG. 2 should be understood to be one of many possible embodiments according to the invention. A coil body 60 surrounds a hub 72 which receives the shaft of a vehicle or piece of equipment. An electromagnetic coil 62 and a plurality of coil springs 64 (only one shown) are housed within the coil body 60. Springs 64 are in contact with an armature plate 66 positioned on one side of the coil body 60. A mounting plate 70 is fixed in place around the hub 72, and supports a brake pad 68 securely mounted on the side of the mounting plate 70 facing the armature plate 66 and the coil body 60. The brake plate 68 interfaces the mounting plate 70 in a parallel relationship. The armature plate 66 is urged by the springs 64 away from the coil body 60, and the armature plate 66 is in electromagnetic communication with the electromagnetic coil 62. The armature plate 66 is in a parallel relationship with the brake pad 68 and the mounting plate 70.

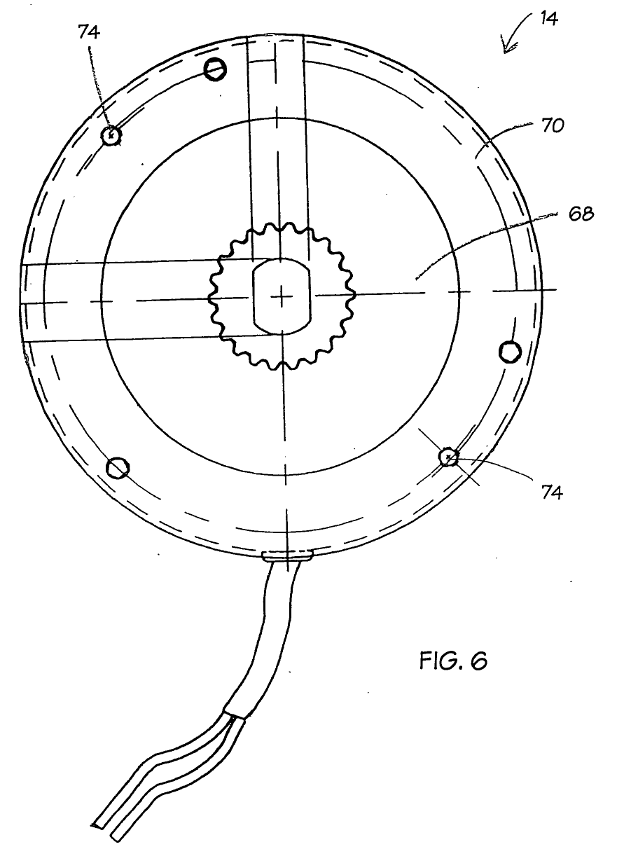

In the embodiment of FIG. 2, a plurality of threaded screw studs 74 (only one shown) are positioned radially outward from and perpendicular to the armature plate 66. Screw studs 74 (only one shown) are positioned circumferentially around mounting plate 70 as shown in FIG. 6. Screw stud 74 extends through mounting plate 70 and has a threaded end for mounting to other equipment, such as a vehicle or conveyor. Screw 74 could be configured the same as screw 54 of FIG. 1, with its head engaging a mounting plate that attaches in some other manner to the edge point. An annular spacer ring 76 surrounds the threaded screw studs 74 on the sides of the threaded screw studs 74 radially outside the threaded screw stud 74.

Referring to FIG. 2, the annular spacer ring 76 is a cylinder having an axis concentric with the axis of rotation of brake 14, and mounting plate 70 and armature plate 66 are normal to spring 76. The annular spacer ring 76 has two ends, one end that contacts the coil body 60 and another end that contacts the mounting plate 70. The annular spacer ring 76 is manufactured from a material of sufficient hardness and strength to create a permanent uniform separation between the coil body 40 and the mounting plate 50 throughout the circumference of the electromagnetic brake assembly 14. Screws 74 are tightened until mounting plate 70 contacts one end of spacer ring 76 and coil body 60 contacts the other end of spacer ring 76.

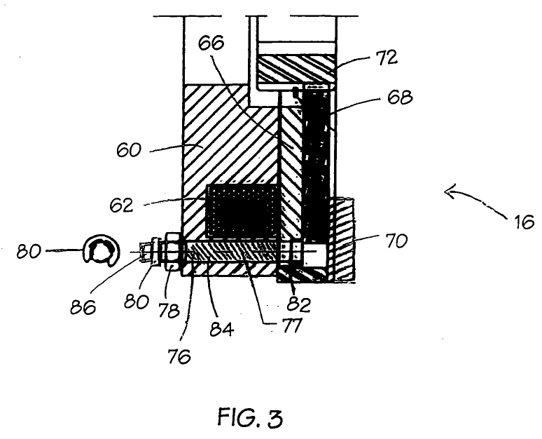

FIG. 3 shows another feature or embodiment of the electromagnetic brake assembly 16 in accordance with the invention. A plurality of threaded screw studs 77 are positioned radially outward from and perpendicular to the armature plate. Preferably there are at least two studs 77, positioned 180 degrees apart from one another. Each threaded screw stud 74 extends through a hole the coil body 60 and has a threaded protruding end 86 that protrudes from the coil body 60 at one end of the threaded screw stud 77. The threaded screw stud 74 may have threads 84 along the entire extent of the threaded screw stud 77, or alternatively may have threads 84 only along an extent of the threaded protruding end 86 of the threaded screw stud 77. The threaded screw stud 77 is rigidly affixed to the armature plate 66 at the end of the threaded screw stud 77 opposite the threaded protruding end 86 of the threaded screw stud 77. One method of securing studs 77 to the armature is by press fitting heads 82 into a hole in the armature 66. Alternatively, studs 77 could be welded or seared or otherwise mounted. The threaded screw stud 77 is secured to the armature plate 66 in a perpendicular relationship to the armature plate 66, such that when the armature plate 66 moves in an axial displacement, the screw stud 77 moves the same displacement as the armature plate 66. There are no threads in the hole in coil body 60, so screw stud 77 moves axially relative to coil body 60.

Further referring to FIG. 3, a nut 78 is preferably threadably engaged to the threads 84 of the threaded protruding end 86 of the threaded screw stud 77. The nut 78 is engaged to the threads 84 of the threaded protruding end 86 such that one side of the nut 78 contacts the side of the coil body 60 then tightened. A snap ring 80 is secured to the threaded protruding end 86 of the threaded screw stud 77 such that the nut 78 is threadably engaged to the threads 84 of the threaded protruding end 86 between the coil body 60 and the snap ring 80. The snap ring 80 operates as a mechanism to prevent the nut 78 from inadvertently falling off the threaded protruding end 86 of the threaded screw stud 77. In normal operations, nut 78 is spaced from coil body 60 so as to not impede axial movement of armature plate 66.

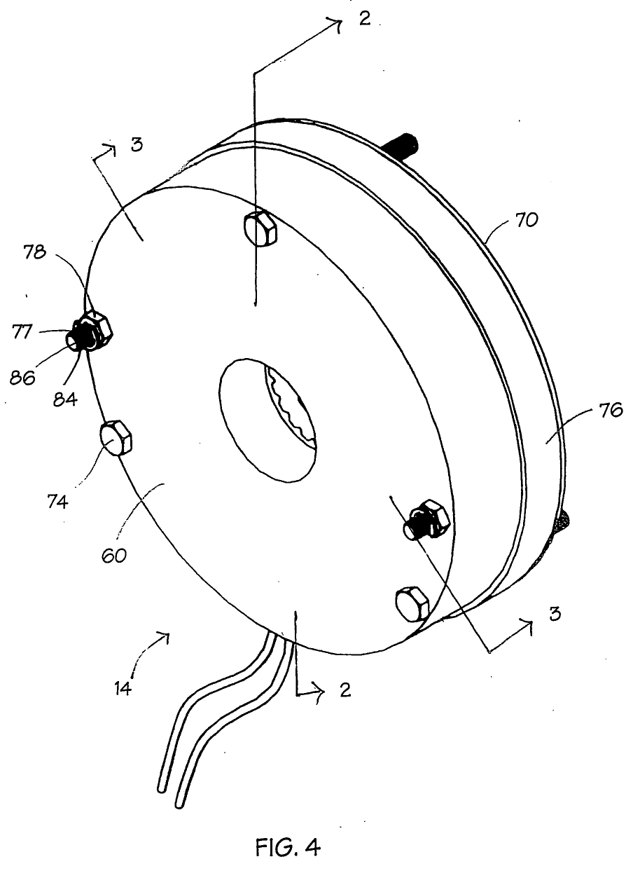

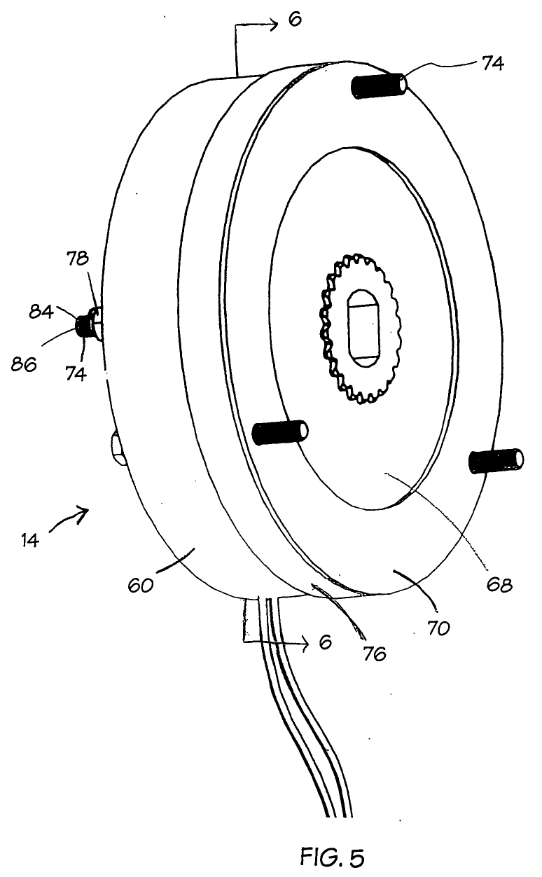

Referring to the varying views of the electromagnetic brake assembly 14 shown in FIGS. 4-6, the annular spacer ring 76 is illustrated as being a hollow cylindrical part that extends throughout the entire circumference of the electromagnetic brake assembly 14. Also, the annular spacer ring 76 is demonstrated as being secured in between the coil body 60 and the mounting plate 70. Furthermore, the nuts 78 are illustrated as being threadably secured with the threads 84 of the threaded protruding end 86 of the threaded screw stud 77. The threaded screw stud 77 and nut 78 are positioned at two locations on the perimeter of the coil body 60, in positions 180 degrees apart from each other. Alternatively, other embodiments may feature more than two sets of threaded screw studs 77 and nuts 78 along the perimeter of the electromagnetic brake assembly 14.

In operation, referring to FIG. 2, the spring 64 is in compressed into a continuous compressive state, and thus continuously applies a force against the armature plate 66 in a direction toward the brake pad 68. When the electromagnetic coil 62 increases magnetic field, the electromagnetic field applies a force to the armature plate 66 that is stronger or greater than the force applied in the opposite direction by the compressed spring 64 against the armature plate 66. The force applied by the electromagnetic field draws the armature plate 66 toward the coil body 60 and away from the brake pad 68. This effectuates a release of the brake pad 68, allowing the vehicle to operate at a selected speed without resistance of the electromagnetic brake assembly 14.

When the electromagnetic coil 62 decreases magnetic field, the compressed spring 64 applies a force to the armature plate 66 that is stronger or greater than the force applied in the opposite direction by the electromagnetic coil 62 against the armature plate 66. The force applied by the compressed spring 64 draws the armature plate 66 away from the coil body 60 and into contact with the brake pad 68. The brake pad 68 is securely mounted to the fixed mounting plate 70, and the fixed mounting plate 70 supports the brake pad 68 when force is applied to the brake pad 68 by the armature plate 66. The greater the force applied to the armature plate 66 against the brake pad 68, the greater the force applied to effectuate a brake on the wheel of the vehicle. This effectuates a slowing of the vehicle or other equipment, allowing the vehicle to gradually slow at an applied deceleration rate through operation of the electromagnetic brake assembly 14.

A problem may sometimes arise when applying the armature plate 66 to the brake pad 68, concerning a situation in which the armature plate 66 may lock-up, whereby the electronic or electromagnetic operation or effect fails and is no longer successful. For example, a failure of electrical power to the coil body 60 causes the brake 14 to lock. In this scenario, release of the armature plate 66 from the brake pad 68 is no longer achievable through electronic or electromagnetic means. If such a problem arises, it is necessary to create a manual operation of releasing the armature plate 66 from the brake pad 68.

In operation, the threaded screw studs 77 and the nuts 78 are utilized to solve such a brake lock-up problem. Nut 78 is rotated around the threaded screw stud 77 until the side of the nut 78 interfaces the side of the coil body 60. To effectuate a manual release of the lock-up effect of the armature plate 66 against the brake pad 68, the nut 78 is rotated about its axis by a wrench or other suitable tool in an axial direction toward the coil body 60. During rotation of the nut 78, the nut 78 achieves angular displacement about the threaded screw stud 77. However, the nut 78 achieves no linear displacement because it is being rotated in contact with the coil body 60. The existence of a positive angular displacement of the nut 78 without linear displacement therewith causes a linear displacement of the threaded screw stud 77 along the axis of the threaded screw stud 77 in a direction opposite the axial direction in which the nut 78 is being rotated. The linear displacement of the threaded screw stud 77 in a direction away from the brake pad 68 causes the armature plate 66, which is rigidly affixed to the threaded screw stud 77, to move a displacement equal to the displacement of the threaded screw stud 77 in the same direction as the threaded screw stud 77. Such a condition effectuates a manual release of the armature plate 66 from the brake pad 68, thus eliminating the lock-up effect of the electromagnetic brake assembly 14.

Although some embodiments of the present invention have been described in detail, it should be understood that various changes, substitutions, and alterations can be made hereupon without departing from the principle and scope of the invention. Accordingly, the scope of the present invention should be determined by the following claims and their appropriate legal equivalents.

1. An electromagnetic brake apparatus for decelerating a rotating shaft of a piece of equipment, comprising:
a coil body having an axis;
an electromagnetic coil and a spring housed in the coil body;
a brake pad having a hub for attachment to the shaft for rotation therewith relative to the coil body;
a mounting plate spaced from the coil body;
an armature plate between the spring and the brake pad in electromagnetic communication with the electromagnetic coil, the armature plate being carried by the coil body to prevent rotation but allow axial movement relative to the coil body, the armature plate being drawn toward the coil body and away from the brake pad when the electromagnetic coil increases the magnetic field, and the armature plate being forced by the spring away from the coil body and into contact with the brake pad when the electromagnetic coil decreases the magnetic field;
an annular spacer ring extending circumferentially around the axis of the coil body and radially outward from a perimeter of the brake pad, the spacer ring having one edge that abuts the coil body and an opposite endue that abuts the mounting plate; and
a plurality of threaded fasteners extending from the coil body to the mounting plate for rigidly securing the coil body to the mounting plate with the spacer ring rigidly clamped therebetween to fix a desired distance between the coil body and the mounting plate, the fasteners being spaced circumferentially around the coil body radially outward of the perimeter of the brake pad.

2. (canceled)

3. (canceled)

4. The apparatus of claim 1, wherein the spacer ring extends around and encloses the fasteners.

5. The apparatus of claim 1, further comprising:
a plurality of release stems, each extending through a hole in the coil body adjacent a perimeter of the coil body and being movable relative to the coil body, each of the release stems having a first end that protrudes from the coil body, each of the release stems having a second end rigidly affixed to the armature plate; and
a manually operable jack member engaged with the first end of each of the release stems so that moving the jack member to a released position thereby moves the release stem relative to the coil body to pull the armature plate away from the brake pad.

6. The apparatus of claim 1, further comprising:
a plurality of threaded members, each extending through a hole in the coil body adjacent a perimeter of the coil body and having a first end that protrudes from the coil body, each of the threaded members having a second end rigidly affixed to the armature plate, the threaded members being linearly movable without rotation relative to the coil body; and
a nut threadably engaged with the first end of each of the threaded members so that when the nuts are rotated in a first direction about the threaded members in contact with the coil body, the threaded members move linearly relative to the coil body to pull the armature plate away from the brake pad.

7. The apparatus of claim 6, further comprising a retainer on the first end of each of the threaded members that limits rotation of each of the nuts in a second direction.

8. An electromagnetic brake apparatus for decelerating a rotating shaft of a piece of equipment, comprising:
an annular coil body;
an electromagnetic coil and a plurality of springs housed in the coil body, the springs spaced around an axis of the coil body;
a brake pad having a hub for securing the brake pad to the shaft for rotation therewith;
a mounting plate rigidly secured to the coil body;
an armature plate mounted between the springs and the brake pad in electromagnetic communication with the electromagnetic coil and non rotatable relative to the coil body, the armature plate being drawn toward the coil body and away from the brake pad when the electromagnetic coil increases the magnetic field, and the armature plate being forced by the spring away from the coil body and into contact with the brake pad when the electromagnetic coil decreases the magnetic field;
a plurality of manual release assemblies circumferentially spaced apart from each other relative to the axis of the coil body, each of the assemblies comprising a stem extending through the coil body and having a threaded end that protrudes from the coil body, each of the stems being rigidly affixed to the armature plate and non rotatable relative to the coil body; and
a nut threadably engaged with the end of each of the stems, one side of each of the nuts interfacing the coil body when the nuts are rotated about the stems to move the stems linearly relative to the coil body, thereby moving the armature plate away from the brake pad to manually release the brake apparatus.

9. The apparatus of claim 8, further comprising a retainer positioned on the threaded end of each of the stems to retain each of the nuts.

10. The apparatus of claim 8, wherein each of the stems is substantially perpendicular to the armature plate.

11. The apparatus of claim 8, further comprising:
an annular spacer ring extending circumferentially around the axis of the coil body having one edge in abutment with the coil body and another edge in abutment with the mounting plate; and
a plurality of fasteners spaced circumferentially around the axis of the coil body radially outward of the brake pad, each of the fasteners having one end secured to the coil body and one end secured to the mounting plate, the fasteners rigidly clamping the spacer ring between the coil body and the mounting plate.

12. An electromagnetic brake apparatus for decelerating a rotating shaft of a piece of equipment, comprising:
a coil body having an axis;
an electromagnetic coil and a spring housed in the coil body;
a brake pad having a hub for securing to the shaft for rotation therewith relative to the coil body;
a mounting plate spaced from the coil body;
a non rotatable armature plate between the spring and the brake pad in electromagnetic communication with the electromagnetic coil, the armature plate being drawn toward the coil body and away from the brake pad when the electromagnetic coil increases the magnetic field, and the armature plate being forced by the spring away from the coil body and into contact with the brake pad when the electromagnetic coil decreases the magnetic field;
an annular spacer ring extending circumferentially around an axis of the coil body between the coil body and the mounting plate and radially outward of a perimeter of the brake pad, the annular spacer ring having one edge in abutment with the mounting plate and one edge in abutment with the coil bode, thereby fixing the amount of separation between the coil body and the mounting plate; and
a plurality of fasteners spaced around the axis, each of the fasteners extending from the coil body to the mounting plate, rigidly clamping the spacer ring between the coil body and the mounting plate, and wherein the spacer ring extends around the fasteners.

13. The apparatus of claim 12, further comprising
a plurality of threaded members, each extending through a hole in the coil body spaced radially from the axis of the coil body, each of the threaded members having a first end that protrudes from the coil body and a second end rigidly affixed to the armature plate, the threaded members being non rotatable and axially movable relative to the coil body;
a nut threadably engaged with the first end of each of the threaded members so that when the nuts are rotated in a first direction about the threaded members in contact with the coil body, the threaded members move axially relative to the coil body to pull the armature plate away from the brake pad to manually release the brake assembly; and
a retainer on the first end of each of the threaded members that limits the amount of rotation of each the nuts in a second direction.
